(19) United States
(12) Patent Application Publication
(10) Pub. No.: US 2026/0312617 A1
(43) Pub. Date: Oct. 8, 2026

(54) METHODS AND APPARATUS FOR INCREASING CAPABILITY OF REDUCED CAPABILITY USER EQUIPMENT WITH FREQUENCY HOPPING

(71) Applicant: Nokia Technologies Oy, Espoo (FI)

(72) Inventors: Ryan KEATING, Naperville, IL (US); Hyun-Su CHA, Naperville, IL (US)

(21) Appl. No.: 19/479,138

(22) PCT Filed: May 7, 2024
(86) PCT No.: PCT/IB2024/054450

§ 371 Date: Oct. 27, 2025

Related U.S. Application Data
(60) Provisional application No. 63/501,950, filed on May 12, 2023.

(51) Int. Cl. H04B 1/7143; H04L 5/00; H04W 72/0453

(52) U.S. Cl. CPC H04B 1/7143; H04L 5/0094; H04W 72/0453

(57) ABSTRACT

Techniques are provided for facilitating uplink frequency hopping patterns for a reduced capability user equipment. In the context of a method performed by user equipment, a reception of information regarding an uplink sounding reference signal frequency hopping pattern for positioning is received. The method also includes determining a frequency domain allocation to implement the uplink sounding reference signal frequency hopping pattern. The method further includes, causing transmission of sounding reference signals in accordance with the frequency domain allocation that implements the uplink sounding reference signal frequency hopping pattern to at least one base station. Corresponding method, apparatus, and computer-readable storage mediums are also provided for a primary and a target cell.

### RELATED APPLICATION

This application claims priority to U.S. provisional Application No. 63/501,950 filed May 12, 2023, which is incorporated herein by reference in its entirety.

### TECHNOLOGICAL FIELD

An example embodiment relates generally to techniques for wireless communication and, more particularly, to techniques for configuring reduced capability user equipment including, for example, configuring reduced capability user equipment with a frequency hopping pattern.

### BACKGROUND

In order to improve the bandwidth capability of a reduced capability user equipment (RedCap UE), uplink (UL) frequency hopping (FH) patterns have been developed to enable the RedCap UE to transmit on a relatively narrow radio frequency (RF) bandwidth (BW) in any one hop, but to aggregate transmissions over multiple hops to achieve a larger effective bandwidth. For example, the RedCap UE may transmit sounding reference signal (SRS) over a plurality of different hops in a staircase pattern. This approach enables the RedCap UE to transmit over a plurality of hops with each adjacent hop fully occupying the next frequency chunk. However, the frequency domain multiplexing options for this pattern are limited since only one single UE can be allocated to the specific frequency hopping pattern for any one symbol. In another example, an uplink (UL) frequency hopping (FH) pattern for two UEs may be assigned to the individual UEs. However, only two UEs can be assigned to the uplink (UL) frequency hopping (FH) patterns without creating interference due to the limitations on the frequency domain multiplexing options. As such, although frequency hopping provides for a larger effective uplink bandwidth for a reduced capacity UE, the uplink frequency hopping patterns limit the number of UEs with which a base station can communicate via an uplink frequency hopping pattern at any one time as a result of interference between the uplink signals.

### BRIEF SUMMARY

Various embodiments generally relate to techniques for facilitating an uplink frequency hopping pattern for user equipment. As such, the method, apparatus and computer program product of an example embodiment may increase the effective bandwidth of a reduced capability user equipment.

In an example embodiment, a method is provided that includes receiving information regarding an uplink sounding reference signal frequency hopping pattern for positioning. The method also includes determining a frequency domain allocation to implement the uplink sounding reference signal frequency hopping pattern. The method further includes causing transmission of sounding reference signals. The transmission of sounding reference signals may be in accordance with the frequency domain allocation that implements the uplink sounding reference signal frequency hopping pattern to at least one base station.

The method of an example embodiment comprises information regarding the uplink sounding reference signal frequency hopping pattern comprises an indication of the starting hop location and relative offsets of subsequent hops. In an example embodiment, the uplink sounding reference signal frequency hopping pattern comprises one or more frequency hopping patterns, wherein each individual hopping pattern is associated with an index. In this example embodiment, receiving information that comprises receiving an indication of the index associated with one or more frequency hopping patterns via radio resource control and/or downlink control information.

The method of an example embodiment the information regarding the uplink sounding reference signal frequency hopping pattern for positioning comprises an index or a starting hop associated with a pre-defined or pre-configured hopping pattern. In this example embodiment, the pre-defined or pre-configured hopping pattern includes a hopping pattern comprising frequency hop locations 1, 4, 2, 3, and 0, sequentially. In an example embodiment, determining the frequency domain allocation comprises determining a relative location of one or more physical resource blocks of a frequency hop that overlap a portion of another frequency hop and identifying the one or more physical resource blocks of the frequency hop to be located at the top or bottom of the frequency domain allocation of the frequency hop. In this example embodiments, the method also includes configuring one or more uplink frequency hopping patterns based on the frequency domain allocation, a number of frequency hops, and/or the relative location of one or more physical resource blocks. In this example embodiment, the method further includes receiving at least one of the number of frequency hops and/or a starting hop of the frequency hopping pattern.

In another example embodiment, an apparatus is provided that includes at least one processor and at least one memory storing instructions, that, when executed by the at least one processor, cause the apparatus to receive information regarding an uplink sounding reference signal frequency hopping pattern for positioning. The apparatus is also caused to determine a frequency domain allocation to implement the uplink sounding reference signal frequency hopping pattern. The apparatus is further caused to cause transmission of sounding reference signals in accordance with the frequency domain allocation that implements the uplink sounding reference signal frequency hopping pattern to at least one base station.

The apparatus of an example embodiment is caused to receive the information regarding the uplink sounding reference signal frequency hopping pattern comprises an indication of the starting hop location and relative offsets of subsequent hops. The apparatus of an example embodiment is caused to receive uplink sounding reference signal frequency hopping pattern comprises one or more frequency hopping patterns, wherein each individual hopping pattern is associated with an index. In this example embodiment, the information that is received comprise an indication of the index associated with one or more frequency hopping patterns via radio resource control and/or downlink control information.

The apparatus of an example embodiment is caused to receive information regarding the uplink sounding reference signal frequency hopping pattern for positioning comprises an index or a starting hop associated with a pre-defined or pre-configured hopping pattern. In this example embodiment, the pre-defined or pre-configured hopping pattern includes a hopping pattern comprising frequency hop locations 1, 4, 2, 3, and 0, sequentially. The apparatus of an example embodiment is caused to determine the frequency domain allocation comprises determining a relative location of one or more physical resource blocks of a frequency hop that overlap a portion of another frequency hop and identifying the one or more physical resource blocks of the frequency hop to be located at the top or bottom of the frequency domain allocation of the frequency hop. In this example embodiment, the apparatus is further caused to configure one or more uplink frequency hopping patterns based on the frequency domain allocation, a number of frequency hops, and/or the relative location of one or more physical resource blocks. In this example embodiment, the apparatus is further caused to receive at least one of the number of frequency hops and/or a starting hop of the frequency hopping pattern.

In a further example embodiment, a non-transitory computer-readable storage medium is provided that includes program instructions stored thereon for receiving information regarding an uplink sounding reference signal frequency hopping pattern for positioning. The program instructions are also for determining a frequency domain allocation to implement the uplink sounding reference signal frequency hopping pattern. The program instruction are further for causing transmission of sounding reference signals in accordance with the frequency domain allocation that implements the uplink sounding reference signal frequency hopping pattern to at least one base station.

The program instructions for receiving information regarding the uplink sounding reference signal frequency hopping pattern comprises an indication of the starting hop location and relative offsets of subsequent hops. The program instructions for receiving the uplink sounding reference signal frequency hopping pattern comprises one or more frequency hopping patterns, wherein each individual hopping pattern is associated with an index. In this example embodiment, the information that is received comprise an indication of the index associated with one or more frequency hopping patterns via radio resource control and/or downlink control information. The program instruction for receiving information regarding the uplink sounding reference signal frequency hopping pattern for positioning comprises an index or a starting hop associated with a pre-defined or pre-configured hopping pattern. In this example embodiment, the pre-defined or pre-configured hopping pattern includes a hopping pattern comprising frequency hop locations 1, 4, 2, 3, and 0, sequentially.

The program instructions for determining the frequency domain allocation comprises determining a relative location of one or more physical resource blocks of a frequency hop that overlap a portion of another frequency hop and identifying the one or more physical resource blocks of the frequency hop to be located at the top or bottom of the frequency domain allocation of the frequency hop. In this example embodiment, further include instructions configured to configure one or more uplink frequency hopping patterns based on the frequency domain allocation, a number of frequency hops, and/or the relative location of one or more physical resource blocks. In this example embodiment, further include instructions configured to receive at least one of the number of frequency hops and/or a starting hop of the frequency hopping pattern.

In yet another example embodiment, an apparatus is provided that includes means for receiving information regarding an uplink sounding reference signal frequency hopping pattern for positioning. The apparatus also includes means for determining a frequency domain allocation to implement the uplink sounding reference signal frequency hopping pattern. The apparatus further includes means for causing transmission of sounding reference signals in accordance with the frequency domain allocation that implements the uplink sounding reference signal frequency hopping pattern to at least one base station.

The means for receiving the information regarding the uplink sounding reference signal frequency hopping pattern comprises an indication of the starting hop location and relative offsets of subsequent hops. The means for receive for uplink sounding reference signal frequency hopping pattern comprises one or more frequency hopping patterns, wherein each individual hopping pattern is associated with an index. In this example embodiment, the information that is received comprise an indication of the index associated with one or more frequency hopping patterns via radio resource control and/or downlink control information. In an example embodiment, the information regarding the uplink sounding reference signal frequency hopping pattern for positioning comprises an index or a starting hop associated with a pre-defined or pre-configured hopping pattern. In this example embodiment, the pre-defined or pre-configured hopping pattern includes a hopping pattern comprising frequency hop locations 1, 4, 2, 3, and 0, sequentially.

The means for determining the frequency domain allocation comprise means for determining a relative location of one or more physical resource blocks of a frequency hop that overlap a portion of another frequency hop and identifying the one or more physical resource blocks of the frequency hop to be located at the top or bottom of the frequency domain allocation of the frequency hop. In this example embodiment, the apparatus further includes means for configuring one or more uplink frequency hopping patterns based on the frequency domain allocation, a number of frequency hops, and/or the relative location of one or more physical resource blocks. In this example embodiment, the apparatus further includes means for receiving at least one of the number of frequency hops and/or a starting hop of the frequency hopping pattern.

In an example embodiment, a method is provided that includes receiving a request for configuring at least one user equipment with an uplink sounding reference signal frequency hopping pattern. The method also includes determining the at least one uplink sounding reference signal frequency hopping pattern for the at least one user equipment. The method further includes causing the at least one user equipment to be configured with the uplink sounding reference signal frequency hopping pattern for positioning. The causing of the at least one user equipment may be configured comprises causing an indication to be provided as to a relative location of one or more physical resource blocks of a frequency hop that overlap a portion of another frequency hop.

The method of an example embodiment also includes determining the frequency hops of an uplink sounding reference signal frequency hopping pattern of a respective user equipment based on an uplink sounding reference signal frequency hopping pattern of one or more other user equipment. In this example embodiment, the method also includes measuring at least one uplink sounding reference signal provided by a respective user equipment in accordance with the uplink sounding reference signal frequency hopping pattern. In this example embodiment, the method further includes causing a report of measurements of the uplink sounding reference signal to be generated and transmitted to a location management function.

The method of an example embodiment, the relative location of the one or more physical resource blocks of the frequency hop that overlap the portion of another frequency hop identifies the one or more physical resource blocks of the frequency hop to be located at the top or bottom of a frequency domain allocation of the frequency hop. In this example embodiment, an indication of the one or more physical resource blocks that overlap the portion of another frequency hop is determined based on a top and/or bottom physical resource block of a carrier. In an example embodiment, the method further includes causing transmission of the uplink sounding reference signal frequency hopping pattern to a location management function.

In another example embodiment, an apparatus is provided that includes at least one processor and at least one memory storing instructions that, when executed by the at least one processor, cause the apparatus at least to receive a request for configuring at least one user equipment with an uplink sounding reference signal frequency hopping pattern. The request may comprise an indication as to a relative location of one or more physical resource blocks of a frequency hop that overlap a portion of another frequency hop. The instructions are also configured to determine at least one uplink sounding reference signal frequency hopping pattern for the at least one user equipment. The determination of the uplink sounding reference signal frequency hopping pattern may be based at least in part upon the indication as to the relative location of one or more physical resource blocks of the frequency hop that overlap a portion of another frequency hop. The instructions are further configured to cause the at least one user equipment to be configured with the uplink sounding reference signal frequency hopping pattern for positioning.

The instructions of an example embodiment are further configured to determine the frequency hops of an uplink sounding reference signal frequency hopping pattern of a respective user equipment based on an uplink sounding reference signal frequency hopping pattern of one or more other user equipment. In an example embodiment, the instructions are further configured to measure at least one uplink sounding reference signal provided by a respective user equipment in accordance with the uplink sounding reference signal frequency hopping pattern. In an example embodiment, the instructions are further configured to cause a report of measurements of the uplink sounding reference signal to be generated and transmitted to a location management function.

The instructions of an example embodiment to determine the relative location of the one or more physical resource blocks of the frequency hop that overlap the portion of another frequency hop identifies the one or more physical resource blocks of the frequency hop to be located at the top or bottom of a frequency domain allocation of the frequency hop. In an example embodiment, an indication of the one or more physical resource blocks that overlap the portion of another frequency hop is determined based on a top and/or bottom physical resource block of a carrier. In this example embodiment, the instructions are further configured to cause the apparatus to cause transmission of the uplink sounding reference signal frequency hopping pattern to a location management function.

In a further example embodiment, a non-transitory computer-readable storage medium is provided that includes program instructions stored thereon for receiving a request for configuring at least one user equipment with an uplink sounding reference signal frequency hopping pattern. The program instructions are also configured for determining the at least one uplink sounding reference signal frequency hopping pattern for the at least one user equipment. The program instructions are further configured for causing the at least one user equipment to be configured with the uplink sounding reference signal frequency hopping pattern for positioning. The causing of the at least one user equipment to be configured comprises causing an indication to be provided as to a relative location of one or more physical resource blocks of a frequency hop that overlap a portion of another frequency hop.

The non-transitory computer-readable storage medium of an example embodiment also includes instruction for determining the frequency hops of an uplink sounding reference signal frequency hopping pattern of a respective user equipment based on an uplink sounding reference signal frequency hopping pattern of one or more other user equipment. In an example embodiment, he non-transitory computer-readable storage medium of an example embodiment also includes instruction for measuring at least one uplink sounding reference signal provided by a respective user equipment in accordance with the uplink sounding reference signal frequency hopping pattern. In this example embodiment, the instructions are further configured to cause a report of measurements of the uplink sounding reference signal to be generated and transmitted to a location management function.

The non-transitory computer-readable storage medium of an example embodiment is configured to determine the relative location of the one or more physical resource blocks of the frequency hop that overlap the portion of another frequency hop identifies the one or more physical resource blocks of the frequency hop to be located at the top or bottom of a frequency domain allocation of the frequency hop. In this example embodiment, the instructions are configured to cause an indication of the one or more physical resource blocks that overlap the portion of another frequency hop is determined based on a top and/or bottom physical resource block of a carrier. In an example embodiment, the instructions are further configured to cause transmission of the uplink sounding reference signal frequency hopping pattern to a location management function.

In yet another example embodiment, an apparatus is provided that includes means for receiving a request for configuring at least one user equipment with an uplink sounding reference signal frequency hopping pattern. The apparatus also includes means for determining the at least one uplink sounding reference signal frequency hopping pattern for the at least one user equipment. The apparatus further includes means for causing the at least one user equipment to be configured with the uplink sounding reference signal frequency hopping pattern for positioning. The causing of the at least one equipment may further comprise causing an indication to be provided as to a relative location of one or more physical resource blocks of a frequency hop that overlap a portion of another frequency hop.

The apparatus of an example embodiment also includes means for determining the frequency hops of an uplink sounding reference signal frequency hopping pattern of a respective user equipment based on an uplink sounding reference signal frequency hopping pattern of one or more other user equipment. In this example embodiment, the apparatus further includes means for measuring at least one uplink sounding reference signal provided by a respective user equipment in accordance with the uplink sounding reference signal frequency hopping pattern. In this example embodiment, the apparatus further includes means for causing a report of measurements of the uplink sounding reference signal to be generated and transmitted to a location management function.

The apparatus of an example embodiment includes means for determining the relative location of the one or more physical resource blocks of the frequency hop that overlap the portion of another frequency hop identifies the one or more physical resource blocks of the frequency hop to be located at the top or bottom of a frequency domain allocation of the frequency hop. In this example embodiment, the apparatus is configured for determining an indication of the one or more physical resource blocks that overlap the portion of another frequency hop is determined based on a top and/or bottom physical resource block of a carrier. In this example embodiment, the apparatus further includes means for causing transmission of the uplink sounding reference signal frequency hopping pattern to a location management function.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates an example of a communication system in accordance with an example embodiment of the present disclosure;

FIG. 2 illustrates a block diagram of an apparatus that may be configured in accordance with an example embodiment of the present disclosure;

FIG. 3 illustrates an example diagram of frequency hopping in accordance with an example embodiment of the present disclosure;

FIG. 4 illustrates an example diagram of frequency hopping in accordance with another example embodiment of the present disclosure;

FIG. 5A illustrates a signal diagram of the uplink frequency hopping operation in accordance with an example embodiment of the present disclosure;

FIG. 5B illustrates a signal diagram of the uplink frequency hopping operation in accordance with an example embodiment of the present disclosure;

FIG. 6 illustrates an example workflow implemented by at least one user equipment in accordance with an example embodiment of the present disclosure; and

FIG. 7 illustrates an example workflow implemented by at least one base station in accordance with an example embodiment of the present disclosure.

### DETAILED DESCRIPTION

Some embodiments of the present disclosure will now be described more fully hereinafter with reference to the accompanying drawings, in which some, but not all, embodiments are shown. Indeed, various embodiments of the present disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of. Furthermore, to the extent that the terms “includes” and “including,” and variants thereof are used in either the detailed description or the claims, these terms are intended to be inclusive in a manner similar to the term “comprising.”

The phrases “in one embodiment,” “according to one embodiment,” “in some embodiments,” “in various embodiments”, and the like generally refer to the fact that the particular feature, structure, or characteristic following the phrase may be included in at least one embodiment of the present disclosure, but not necessarily all embodiments of the present disclosure. Thus, the particular feature, structure, or characteristic may be included in more than one embodiment of the present disclosure such that these phrases do not necessarily refer to the same embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

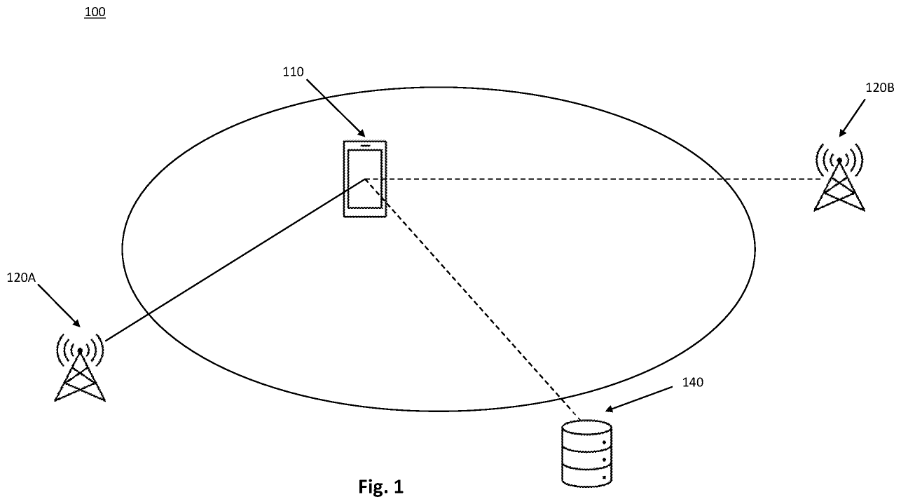

As illustrated in FIG. 1, a communication system 100 is provided in accordance with various embodiments of the present disclosure. In some embodiments, the communication system may comprise at least one user equipment (UE) 110, a plurality of base stations 120A and 120B (collectively “120”), and at least one location management function (LMF) 140 that are capable of being in communication with each other and to receive uplink (UL) transmission, such as from the UE. The UE 110 may be configured to operate in two or more frequency bands, such as three or four frequency bands in some embodiments. In some embodiments, the frequency bands may be called frequency chunks or frequency hops. With respect to at least some, but not necessarily all, of the frequency bands, the UE 110 may be configured to establish an uplink (UL) sounding reference signal (SRS) frequency hopping (FH) pattern. Additionally, different base stations may be configured to operate in different ones of the frequency bands, such as the FR1 band, the FR2 band, etc. In some embodiments, the different base stations may be operated by different carriers. As described below, the apparatus, method and computer program product of an example embodiment are configured to implement an uplink (UL) frequency hopping (FH) configuration process as described herein that is based upon empty top and/or bottom physical resource blocks (PRBs) of the UE 110 (relative to a respective hop with the top PRBs having the greatest frequencies of the respective hop and the bottom PRBs having the lowest frequencies of the respective hop).

By way of example, the communication system 100 may be deployed within a radio access architecture based on long term evolution advanced (LTE Advanced, LTE-A) and/or new radio (NR, 5G). However, the system may be deployed in other network architectures including within other communication networks including, for example, other communication networks developed in the future, e.g., sixth generation (6G) networks, as well as any of a number of existing networks including a universal mobile telecommunication system (UMTS), radio access network (UTRAN or E-UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The UE 110 may be any type of user terminal, terminal device, etc. to which resources on the air interface are allocated and assigned. For example, the UE may be a portable computing device such as a wireless mobile communication device including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. The user equipment may also be called a subscriber unit, mobile station, remote terminal, access terminal, user terminal or user equipment (UE) just to mention but a few names or apparatuses.

The at least one base station 120, is a network element and may be embodied by any of a variety of access points including, for example, a Node B, e.g., a gNB, or the like. The at least one location management function (LMF) 140, is also a network element and may be embodied by any of a variety of network nodes or functions including, for example, a server, a repository, a memory device, or the like.

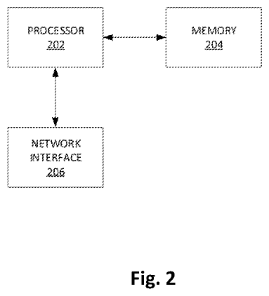

Referring now to FIG. 2, an example apparatus 200 is provided. The apparatus 200 may be an embodiment of a UE 110 and/or may be embodied by, in communication with or otherwise associated with a UE 110, in some instances. Alternatively, the apparatus 200 may be an embodiment of a network element or may be embodied by or otherwise associated with a network element and, as such may be embodied by an access point, e.g., at least one base station 120, at least one additional base station 130, and/or at least once location management function 140.

The apparatus 200 may include processor 202, memory 204, and network interface 206. The apparatus 200 may be configured to execute the operations described herein. Although these components are described with respect to the performance of various functions, it should be understood that the particular implementations necessarily include the use of particular hardware. It should also be understood that certain of these components may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with an example embodiment disclosed herein.

The processor 202 may be embodied in a number of different ways and may, for example, include one or more processing devices configured to perform independently. In some non-limiting embodiments, the processor 202 may include one or more processors configured in tandem via a bus to enable independent execution of instructions, pipelining, and/or multithreading. The use of the term “processor” may be understood to include a single core processor, a multi-core processor, multiple processors internal to the apparatus, and/or remote or “cloud” processors.

In some embodiments, the processor 202 may be configured to execute instructions stored in the memory 204 and/or circuitry otherwise accessible to the processor 202. In some embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment disclosed herein while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may optionally include input/output circuitry that may, in turn, be in communication with processor 202 to provide output to a user and/or other entity and, in some embodiments, to receive an indication of an input. The input/output circuitry may comprise a user interface and may include a display, and may comprise a web user interface, a mobile application, a query-initiating computing device, a kiosk, or the like. In some embodiments, the input/output circuitry may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The network interface 206 may be any means such as a device or circuitry embodied in either hardware or a combination of hardware and software that is configured to receive and/or transmit data from/to a network, e.g., one or more of the base stations 120A, 120B and/or any other device, circuitry, or module in communication with the apparatus 200. In this regard, the network interface 206 may include, for example, a network interface for enabling communications with a wired or wireless communication network. For example, the network interface 206 may include one or more network interface cards, antennae, buses, switches, routers, modems, and supporting hardware and/or software, or any other device suitable for enabling communications via a network. Additionally, or alternatively, the network interface 206 may include the circuitry for interacting with the antenna/antennae to cause transmission of signals via the antenna/antennae or to handle receipt of signals received via the antenna/antennae.

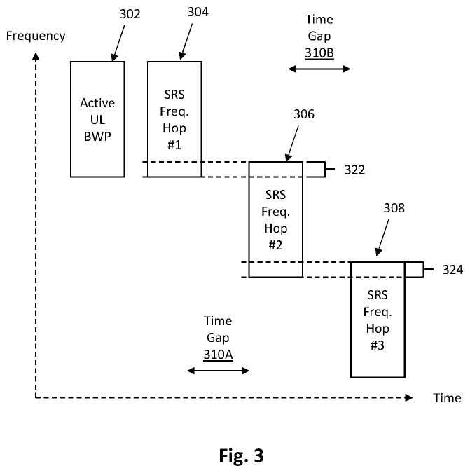

FIG. 3 illustrates an example sounding reference signal (SRS) frequency hopping (FH) pattern for a user equipment (UE) in accordance with various embodiments of the present disclosure. In various embodiments, the UE may comprise an active uplink bandwidth part (UL BWP) 302 at a given carrier frequency. In various embodiments, the UE may be configured to use a sounding reference signal (SRS) frequency hopping (FH) configuration separate from the active UL BWP 302. The separate sounding reference signal (SRS) frequency hopping (FH) configuration may keep the UE radio frequency (RF) limited to a single hop while allowing a network entity (e.g., a base station, a location management function, etc.) to stich or combine a UL signal over a plurality of hops to provide the RedCap UE with an effective wide bandwidth to improve positioning estimation and/or timing estimation accuracy. In some embodiments, the UE may be configured with a predetermined uplink (UL) frequency hopping (FH) sounding reference signal (SRS) configuration for positioning with a determined frequency hopping (FH) pattern from at least one base station. The frequency hopping (FH) pattern may comprise information regarding the allocation of top and/or bottom physical resource blocks (PRBs) to be used for updating the uplink (UL) sounding reference signal (SRS) frequency hopping (FH) pattern. In some embodiments, the uplink (UL) sounding reference signal (SRS) frequency hopping (FH) pattern permits a frequency domain allocation for the sounding reference signal (SRS) frequency hopping (FH) to be determined based on the information regarding the top and/or bottom physical resource blocks are to be allocated and used. In some embodiments, the top and/or bottom PRBs may be the top and/or bottom PRBs within a carrier (e.g., top 4 PRBs in a 100 MHz carrier).

With further reference to FIG. 3, in various embodiments, the base station may indicate a specific uplink (UL) sounding reference signal (SRS) frequency hopping (FH) pattern. The UL SRS FH pattern may be indicated by an offset form, a predefined hopping sequency number, starting hop, and/or one or more relative offsets of subsequent hops. In the depicted embodiments, the RedCap UE may be configured with an uplink (UL) frequency hopping (FH) sounding reference signal (SRS) configuration that is indicated by a predefined hopping sequence number, such as hopping sequence 1, hopping sequence 2, . . . hopping sequence n. The UE may be configured to transmit SRS during a first sounding reference signal (SRS) hop 304, a second sounding reference signal (SRS) hop 306, and/or a third sounding reference signal (SRS) hop 308. The SRS hops are spaced apart in the temporal domain. For example, the first sounding reference signal (SRS) hop 304 and the second sounding reference signal (SRS) hop 306 may be separated by a first predetermined time gap 310A, and the second sounding reference signal (SRS) hop 306 and the third sounding reference signal (SRS) hop 308 may be separated by a second predetermined time gap 310B, which may equal or be different than the first predetermined time gap 310A. The UE may comprise unused top and/or bottom physical resource blocks (PRBs) across the different hops 322, 324.

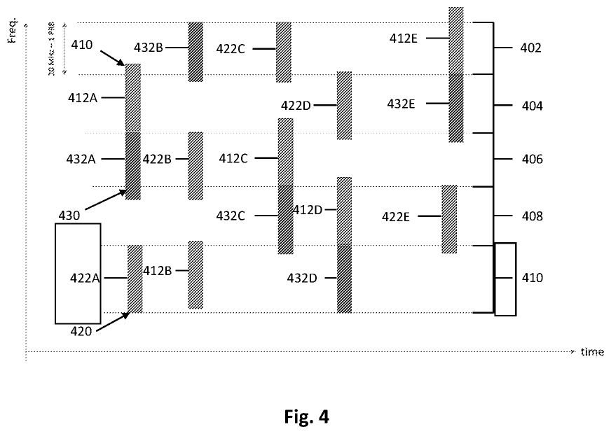

FIG. 4 illustrates an example sounding reference signal (SRS) frequency hopping (FH) pattern for a plurality of user equipment (UE) with the SRS FH patterns being defined in accordance with various embodiments of the present disclosure. In the depicted embodiment, the frequency domain comprises five individual hops 402, 404, 406, 408, and 410. Each hop extends across a predefined frequency bandwidth, such as 20 MHz in FR1. The hops may be ordered in descending numbering, where the first hop 402 is illustrated vertically above the second hop 404 such that the center frequency of the first hop exceeds the center frequency of the second hop by a predetermined amount, such as 20 MHz, the second hop 404 is illustrated above the third hop 406 and so forth. In the depicted embodiment, a first UE 410 may be configured in a manner such that the top physical resource blocks (PRBs) are filled (so as to be capable of being utilized for the transmission of sounding reference signals (SRS) by the first UE), and the bottom physical resource blocks (PRBs) are left blank for configuration by one or more base stations. A second UE 420 may be configured in a manner such that the top and/or bottom physical resource blocks (PRBs) are configured by one or more base stations in an offset form based at least in part on the configuration of the other UEs communicating with the one or more base stations in conjunction with SRS positioning, such as the first UE 410 and/or a third UE 430. The third UE 430 may be configured in a manner such that the bottom physical resource blocks (PRBs) are filled (so as to be capable of being utilized for the transmission of sounding reference signals (SRS) by the third UE), and the top physical resource blocks (PRBs) are left blank for configuration by one or more base stations.

With further reference to FIG. 4, in various embodiments, the first UE may be configured by a base station, which indicates the hopping pattern directly to the first UE 410 in an offset form. In the depicted embodiment, the hops may be 20 MHz with a carrier frequency of 3GHz. Although spaced apart in time, the hops may partially overlap in the frequency domain such that the SRS transmitted by a UE have an effective bandwidth that is larger, typically significantly larger, than the bandwidth of a signal hop. In this regard, the hops of an example embodiment have a frequency overlap of 1 physical resource block (PRB) per hop. The UE may be able to calculate the center frequency of each hop, in a time domain, based on the information provided by the base station. The first UE 410 is configured with a first uplink (UL) frequency hopping (FH) sounding reference signal (SRS) 412A disposed in the first hop 402. By way of example, the frequency center for the first hop may be calculated as F_{c}=3 GHZ+20 MHZ+1 PRB, wherein a PRB is equal to 12*Subcarrier Spacing (12*SCS). The first UE 410 of this example may be configured with a second uplink (UL) frequency hopping (FH) sounding reference signal (SRS) 412B disposed in the fourth hop 408. The frequency center for the fourth hop may be calculated as F_{c}=3 GHz-20 MHZ+3PRB. The first UE 410 may be further configured with a third uplink (UL) frequency hopping (FH) sounding reference signal (SRS) 412C disposed in the second hop 404. The frequency center for the second hop 404 may be calculated as F_{c}=3 GHZ-40 MHZ+4 PRB. In this example, the first UE 410 may be further configured with a fourth uplink (UL) frequency hopping (FH) sounding reference signal (SRS) 412D disposed in the third hop 406. The frequency center for the third hop 406 may be calculated as F_{c}=3 GHz+2 PRB. The first UE 410 may be even further configured with a fifth uplink (UL) frequency hopping (FH) sounding reference signal (SRS) 412E disposed in an additional hop.

With even further reference to FIG. 4, in various embodiments, the base station may configure the second UE 420 with an uplink (UL) frequency hopping (FH) sounding reference signal (SRS) pattern based at least in part on the configuration of the first UE and/or the available top and/or bottom physical resource blocks (PRBs) of the second UE so as to avoid the creation of interference with the first UE. In the depicted embodiment, the second UE 420 may indicate that the bottom PRBs for the component carrier that are filled and the top PRBs for the component carrier that are left blank for configuration by the base station. In various embodiments, the second UE 420 is configured with a first uplink (UL) frequency hopping (FH) sounding reference signal (SRS) 422A disposed in the fifth hop 410. The second UE 420 is further configured with a second uplink (UL) frequency hopping (FH) sounding reference signal (SRS) 422B disposed at least partially in the third hop 406 with available bottom PRBs for transmission of SRS in the fourth hop 408. The second UE 420 is further configured with a third uplink (UL) frequency hopping (FH) sounding reference signal (SRS) 422C disposed at least partially in the first hop 402 with available bottom PRBs for transmission of the SRS in the second hop 404. The second UE 420 is further configured with a fourth uplink (UL) frequency hopping (FH) sounding reference signal (SRS) 422D disposed at least partially in the second hop 404 with possibly available bottom PRBs for transmission of the SRS in the third hop 406 and/or possibly available top PRBs for transmission of the SRS in the first hop 402. The second UE 420 is even further configured with a second uplink (UL) frequency hopping (FH) sounding reference signal (SRS) 422E disposed at least partially in the fourth hop 408 with possibly available bottom PRBs for transmission of the SRS in the fifth hop 410 and/or possibly available top PRBs for transmission of the SRS in the third hop 406.

With even further reference to FIG. 4, in various embodiments, the base station may configure the third UE 430 with an uplink (UL) frequency hopping (FH) sounding reference signal (SRS) pattern based at least in part on the UL FH SRS pattern of the first UE, the second UE, and/or the available top and/or bottom physical resource blocks (PRBs) of the third UE so as to avoid or reduce interference created with the first and second UEs. In the depicted embodiment, the third UE 430 may be configured with a first uplink (UL) frequency hopping (FH) sounding reference signal (SRS) 432A disposed at least partially in the third hop 406 with at least one available top PRB for transmission of the SRS in the second hop 404 and/or at least one available bottom PRB for transmission of the SRS in the fourth hop 408. The third UE 430 may be configured with a second uplink (UL) frequency hopping (FH) sounding reference signal (SRS) 432B disposed at least partially in the first hop 402 with at least one available bottom PRB for transmission of the SRS in the second hop 404. The third UE 430 may be configured with a third uplink (UL) frequency hopping (FH) sounding reference signal (SRS) 432C disposed at least partially in the fourth hop 408 with at least one available bottom PRB for transmission of the SRS in the fifth hop 410. The third UE 430 may be configured with a fourth uplink (UL) frequency hopping (FH) sounding reference signal (SRS) 432D disposed at least partially in the fifth hop 410 and may comprise at least one available top PRB for transmission of the SRS and/or at least one available bottom PRB for transmission of the SRS within the fifth hop 410. The third UE 430 may be configured with a fifth uplink (UL) frequency hopping (FH) sounding reference signal (SRS) 432E disposed at least partially in the second hop 404 and may comprise at least one available bottom PRB for transmission of the SRS in the third hop 406.

With even further reference to FIG. 4, in various embodiments, the uplink (UL) frequency hopping (FH) patterns of the first UE 410, the second UE 420, and/or the third UE 430 may take advantage of at least one top and/or bottom extra physical resource blocks of the individual UEs for transmission of the SRS. The extra top and/or bottom physical resource blocks of the UEs may be left over in the carrier frequency due to the uplink (UL) frequency hopping (FH) overlap in the frequency domain. In the depicted embodiments, the first UE 410, the second UE 420, and/or the third UE 430 may be multiplexed in the frequency domain, thereby permitting for concurrent transmission of SRS for positioning by the three UEs without interference therebetween.

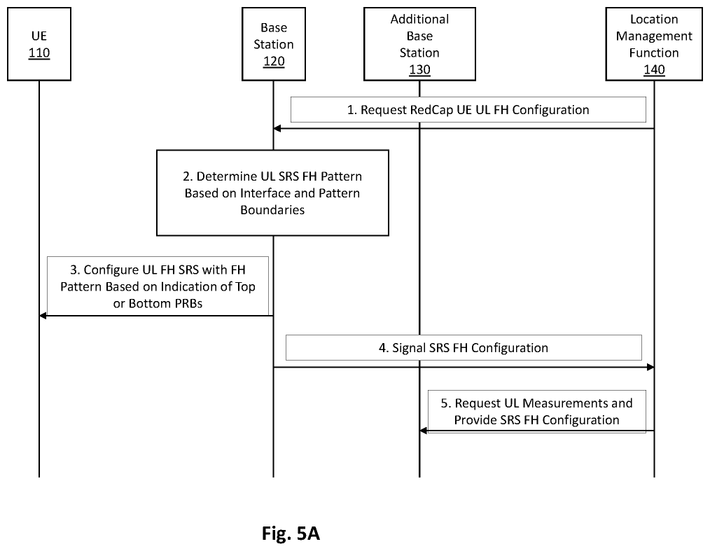

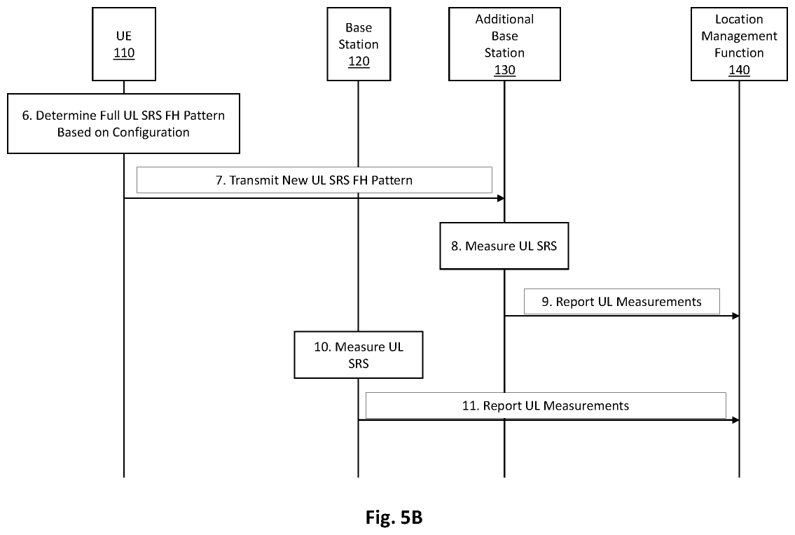

FIGS. 5A and 5B illustrate an example implementation of a signal flow in accordance with an example embodiment in which at least one user equipment 110 (UE) is configured to communicate with at least one base station 120, at least one additional base station 130, and/or at least one location management function 140 (e.g., server, etc.) to establish and utilize an uplink (UL) frequency hopping (FH) pattern for the UE for positioning purposes. The establishment of an uplink (UL) frequency hopping (FH) pattern may be improved in accordance with an example embodiment in various manners, such as determining at least one uplink (UL) sounding reference signal (SRS) frequency hopping (FH) pattern based on one or more available physical resource blocks of the UE. The uplink (UL) sounding reference signal (SRS) frequency hopping (FH) pattern may be based on available top and/or bottom physical resources blocks (PRBs) carrier. Additionally, the network, such as a base station, may provide the uplink (UL) sounding reference signal (SRS) frequency hopping (FH) pattern to the UE in any of a variety of manners.

As described below, in an instance in which the uplink (UL) sounding reference signal (SRS) frequency hopping (FH) pattern is transmitted to the UE by the network, e.g., a base station, the UE may be configured to apply the frequency hopping (FH) pattern indicated by the uplink (UL) sounding reference signal (SRS) frequency hopping (FH) pattern for the transmission of SRS for positioning purposes over a larger frequency bandwidth than provided by an individual hop. The network entity, such as the base station, may determine the available physical resource blocks (PRBs) to determine a frequency hopping (FH) pattern for a given user equipment (UE). In this regard, the network entity, such as the base station, can determine the available physical resource blocks (PRBs) and configure the UE based at least in part on the physical resource blocks (PRBs) allocation.

Returning to FIG. 5A, at operation 1, the apparatus 200 associated with the location management function 140 may include means, such as the processor 202, the network interface 206 or the like, configured to transmit a request to at least one base station 120 to configure a user equipment, such as a reduced capability user equipment (RedCap UE) 110, with an uplink (UL) frequency hopping (FH) pattern. The one or more base stations 120 may receive the request from the location management function 140, wherein the request may further include a request for a sounding reference signal (SRS) to determine a location for the UE.

At operation 2 of FIG. 5A, the apparatus 200 associated with the base station 120 includes means, such as the processor 202, the memory 204, the network interface 206, or the like, for receiving the request from the location management function 140 and determining at least one uplink (UL) sounding reference signal (SRS) frequency hopping (FH) pattern for a given RedCap UE 110. In some embodiments, the base station 120 may further determine at least one uplink (UL) frequency hopping (FH) pattern based at least in part on the UL SRS FH patterns already allocated to other UEs and/or already allocated physical resource blocks (PRBs) of the RedCap UE 110. In some embodiments, the base station 120 may determine one or more empty top and/or bottom physical resource blocks (PRBs) that may be utilized for a frequency hopping (FH) pattern. The top and/or bottom PRBs may be considered empty in an instance in which other UEs configured with an UL FH pattern do not use them with their configurations.

At operation 3 of FIG. 5A, the apparatus 200 associated with the base station 120 includes means, such as the processor 202, the memory 204, the network interface 206, or the like, for configuring the RedCap UE 110 with an uplink (UL) sounding reference signal (SRS) frequency hopping (FH) pattern for determining a position of the UE 110. Additionally, in some embodiments, the base station 120 may configure the UL SRS FH pattern to include at least one physical resource block (PRB) of the UE 110 that overlaps between hops so as to effectively knit multiple hops together in order to extend the bandwidth of the SRS by using one or more empty top and/or bottom PRBs that are otherwise unutilized.

In some embodiments, the base station 120 may configure the UE 110 with an uplink (UL) frequency hopping (FH) pattern directly in the form of offsets (e.g., hop offsets) from a predefined hop, such as the top hop having the greatest frequencies of any of the hops. In an example embodiment, the sounding reference signal (SRS) frequency hopping (FH) pattern provided by the base station 120 to the UE 110 may follow a pattern similar to the first UE pattern (e.g., 410A, 410B, 410C, 410D, 410E) depicted in FIG. 4. With reference to FIG. 4, the frequency hopping (FH) pattern is an offset pattern, wherein the empty top and/or bottom physical resource block (PRBs) follow the pattern of hop 1, hop 4, hop 2,hop 3, hop 0 with the numerical designation being the offset from the top hop.

In other example embodiments, the base station 120 may configure the UE 110 with an uplink (UL) frequency hopping (FH) pattern directly in the form of a frequency hopping sequence, wherein the frequency hopping sequence is predefined for a given UE 110. In various embodiments, the base station 120 may determine a frequency hopping (FH) sequence based at least in part on the empty top and/or bottom physical resource block (PRBs) for the UE 110 in order to reduce interference from one or more additional UEs. In various embodiments, base station 120 may configure the UE 110 with at least one frequency hopping (FH) pattern identifier (ID). The frequency hopping (FH) pattern identifier (ID) provides the UE with the physical resource block allocation, and/or the FH pattern ID may be associated with a sequence of hop offset defining a FH pattern such as hop 1, hop 4, hop 2, hop 3 and hop 0 depicted in FIG. 4. In even further embodiments, the base station 120 may configure the UE 110 with an uplink (UL) frequency hopping (FH) pattern directly in the form of providing the UE 110 with a starting hop and the following hops within the frequency hopping pattern may be determined based on the hops of one or more potentially interfering UEs and/or by the specification for the UE.

Returning back to FIG. 5A, at operation 4, the apparatus 200 associated with the base station 120 may include means, such as the processor 202, the memory 204, the network interface 206, or the like, configured to transmit the determined sounding reference signal (SRS) frequency hopping (FH) pattern for the UE 110 to the at least one location management function 140. Although the UL SRS FH pattern may be transmitted in various manners, the base station 120 may communicate with the location management function 140 via new radio positioning protocol a (NRPPa) in one example embodiment. At operation 5, the apparatus 200 associated with the location management function 140 may include means, such as the processor 202, the memory 204, the network interface 206, or the like, for storing the determined sounding reference signal (SRS) frequency hopping (FH) pattern for the UE 110 and transmitting the sounding reference signal (SRS) frequency hopping (FH) pattern for the UE 110 to one or more additional base stations 130. The location management function 140 may further transmit a request for UL measurements for the UE 110, such as based on SRS transmitted by the UE 110, to the one or more additional base stations 130.

At operation 6 of FIG. 5B, the apparatus 200 associated with the user equipment 110 (UE) may include means, such as the processor 202, the memory 204, or the like, for determining a full uplink (UL) sounding reference signal (SRS) frequency hopping (FH) pattern based at least in part on configuration received from the base station 120. In various embodiments, the UE 110 utilizes the uplink (UL) sounding reference signal (SRS) frequency hopping (FH) pattern received from the base station to determine the full frequency domain allocation of the sounding reference signal (SRS) frequency hopping (FH) pattern based on the top and/or bottom physical resource blocks that have not otherwise been allocated, such as to other UEs.

At operation 7 of FIG. 5B, the apparatus associated with the user equipment 110 (UE) may include means, such as the processor 202, the memory 204, the network interface 206, or the like, for transmitting the new uplink (UL) sounding reference signal (SRS) frequency hopping (FH) pattern to one or more additional base stations 130. The apparatus associated with the user equipment 110 may then transmit UL SRS via the UL SRS FH pattern.

At operations 8-11 of FIG. 5B, the apparatuses associated with one or more base station 120 and/or one or more additional base station 130 may include means, such as the processor 202, the memory 204, the network interface 206, or the like, for measuring one or more uplink (UL) sounding reference signals (SRS) transmitted by the UE(s) for locating at least one UE. Based on the measurements, the base station 120 and/or the one or more additional base stations 130 may transmit the uplink (UL) sounding reference signal (SRS) measurement report to the location management function 140. In some embodiments, operations 8 and 10 may be performed simultaneously (e.g., based on the same SRS FH transmission) and operations 9 and 11 may be performed simultaneously.

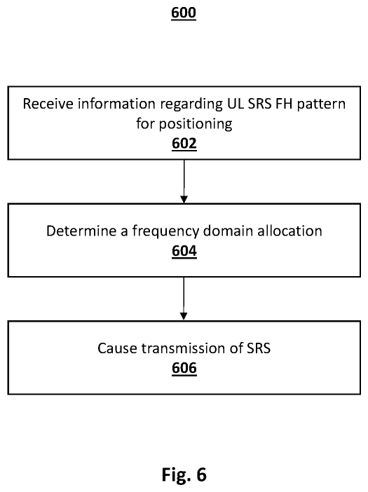

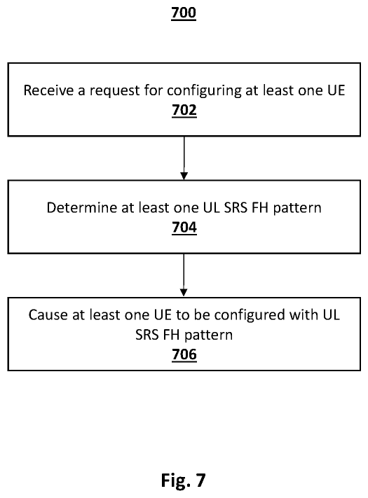

Referring now to FIGS. 6 and 7, example flow charts are provided of operations performed by an apparatus, such as the apparatus of FIG. 2, embodied by one or more user equipment (UE) in regard to FIG. 6 and by one or more base stations in regard to FIG. 7. Referring now to FIG. 6, a method 600 is illustrated that can be carried out by an apparatus 200 as embodied by one or more UEs with the apparatus including means, such as the processor 202, the memory 204, the network interface 206, or the like, for receiving information regarding an uplink (UL) sounding reference signal (SRS) frequency hopping (FH) pattern for positioning. See block 602. The information may be transmitted by a base station to the UE as shown in FIG. 5A. In some embodiments, the UL SRS FH pattern may further comprise information regarding allocations of at least one top and/or bottom physical resource blocks of at least one UE to be utilized by the UL SRS FH pattern. The at least one top and/or bottom physical resource blocks selected for the UL SRS FH pattern have not been allocated to other UEs in order to prevent or reduce the risk of interference. The UL SRS FH pattern may be associated with or defined by an index. The index associated with the UL SRS FH pattern may be used to identify one or more physical resource blocks that overlap a hop, identify at least one of the number of frequency hops of the FH pattern, identify a starting hop of the FH pattern, and/or the like. In some embodiments, the FH patterns may be pre-defined or pre-configured and then associated with an index. For example, the FH pattern with offsets {3, 0, 2, 1, 4} may be associated with pattern index 3. If the UE is configured with pre-defined pattern index 3 then the UE would understand that it should use offsets {3, 0, 2, 1, 4} for the hops of the UL SRS frequency hopping

The apparatus also includes means, such as the processor 202, or the like, for determining a frequency domain allocation to implement the uplink (UL) sounding reference signal (SRS) frequency hopping (FH) pattern, 604. The determination of the frequency domain allocation for at least one UE may comprise determining a relative location of one or more physical resource blocks of a given frequency hop that overlaps a portion of one or more additional frequency hops. In some embodiments, the apparatus further identifies one or more unallocated physical resource blocks of the frequency hop, wherein the unallocated physical resource blocks may be located at the top and/or the bottom of the frequency hop. The apparatus may further determine a frequency associated with each individual frequency hop, wherein the frequency is based at least in part on the relative location of the one or more physical resource blocks. The apparatus further includes means, such as the processor 202, the memory 204, the network interface 206, or the like, for causing transmission of the sounding reference signal to the at least one base station and one or more additional base stations. See block 606. The transmission of the updated sounding reference signal may be in accordance with the frequency domain allocation that implements the UL SRS FH pattern. Based on the sounding reference signals transmitted by the UE, the base station and one or more additional base stations may measure the sounding reference signals and provide a measurement report to the network, such as to the location management function. Based on the SRS measurements provided by the base stations of sounding reference signals transmitted by a UE, positioning information associated with the UE may be determined.

Referring now to FIG. 7, an example flowchart illustrating the operations performed, such as by an apparatus as depicted in FIG. 2 and embodied as the base station. Referring now to FIG. 7, a method 700 is illustrated that can be carried out by an apparatus 200 as embodied by one or more base stations with the apparatus including means, such as the processor 202, the memory 204, the network interface 206, or the like, for receiving a request for configuring at least one user equipment with an uplink (UL) sounding reference signal (SRS) frequency hopping (FH) pattern. See block 702. The request may be transmitted from a location management function (LMF) to the at least one base station as shown in FIG. 5A.

The apparatus further includes means, such as the processor 202, the memory 204, or the like, for determining at least one uplink (UL) sounding reference signal (SRS) frequency hopping (FH) pattern for the at least one UE. See block 704. The apparatus may be configured to determine the at least one UL SRS FH pattern by determining the frequency hops of an uplink sounding reference signal frequency hopping pattern for a respective UE with the frequency hops being based at least in part on an UL SRS FH pattern of one or more other user equipment. The determination of the at least one UL SRS FH pattern may additionally or alternatively include measuring at least one UL SRS provided by a respective UE in accordance with the UL SRS FH pattern.

The apparatus further includes means, such as the processor 202, the memory 204, the network interface 206, or the like, for causing the at least one UE to be configured with the uplink (UL) sounding reference signal (SRS) frequency hopping (FH) pattern for positioning. See block 706. The apparatus may be configured to cause the at least one UE to be configured by causing an indication to be provided as to a relative location of one or more physical resource blocks of a frequency hop that overlap a portion of another frequency hop. The relative location of the one or more physical resource blocks of the frequency hop that overlap a portion of another frequency hop may identify the one or more physical resource blocks of the frequency hop to be located at the top or bottom of the frequency hop. Based on the sounding reference signals transmitted by the UE, the base station and one or more additional base stations may then measure the sounding reference signals provided by a UE in accordance with the UL SRS FH pattern and provide a measurement report to the network, such as to the location management function. Based on the SRS measurements provided by the base stations of sounding reference signals transmitted by a UE, positioning information associated with the UE may be determined.

It should be appreciated that the embodiments described herein are not restricted to the system that is given as an example, such as a fifth generation (5G) system, and that a person skilled in the art may apply the solution to other communication systems including sixth generation (6G) or other communication systems being developed or to be developed in the future. Additionally, although some embodiments described herein in the context of a base station, the method may be performed by other types of network entities in accordance with other example embodiments. While described above in conjunction with symmetric UL SRS FH patterns in which different UEs have the same number of frequency hops, different UEs may utilize UL SRS FH patterns having different numbers of frequency hops in other embodiments, such as in instances in which different UEs have different accuracy requirements. Also, while described in the context of FRI with five 20 MHz hops, the method and apparatus are also applicable to other frequency bands, e.g., FR2, with different numbers of hops.

As described above, the method, apparatus and computer program product of an example embodiment can be provided for improved multiplexing between, for example, three UEs and correspondingly decreased interference between the sounding reference signals transmitted by the UEs as a result of the UL SRS FH patterns defined herein. By allowing a greater number of UEs, e.g., 3 UEs, to be utilized for the provision of positioning services, the positioning capacity is also advantageously improved.

Furthermore, implementations of the various techniques described herein may be implemented in digital electronic circuitry, or in computer hardware, firmware, software, or in combinations of them. Implementations may be implemented as a computer program product, e.g., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer, or it may be distributed amongst a number of computers.

A computer program, such as the computer program(s) described herein, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

The operations of the method may be performed by one or more programmable processors executing a computer program or computer program portions to perform functions by operating on input data and generating output. The operations of the method also may be performed by, and an apparatus may be implemented as, special purpose logic circuitry, e.g., an FPGA (field programmable gate array) or an ASIC (application-specific integrated circuit.

It will be understood that each block of the flowchart(s) and combination of blocks in the flowchart(s) can be implemented by various means, such as hardware, firmware, processor, circuitry, and/or other communication devices associated with execution of software including one or more computer program instructions. For example, one or more of the procedures described herein can be embodied by computer program instructions. In this regard, the computer program instructions which embody the procedures described herein can be stored, for example, by memory 204 of the apparatus 200 associated with the user equipment 110 or other apparatuses employing an embodiment of the present disclosure and executed by the processor 202. As will be appreciated, any such computer program instructions can be loaded onto a computer or other programmable apparatus (for example, hardware) to produce a machine, such that the resulting computer or other programmable apparatus implements the functions specified in the blocks of the flowchart(s). These computer program instructions can also be stored in a computer-readable memory that can direct a computer or other programmable apparatus to function in a particular manner, such that the instructions stored in the computer-readable memory produce an article of manufacture the execution of which implements the function specified in the blocks of the flowchart(s). The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the blocks of the flowchart.

Accordingly, blocks of the flowchart(s) support combinations of means for performing the specified functions and combinations of operations for performing the specified functions for performing the specified functions. It will also be understood that one or more blocks of the flowchart(s), and combinations of blocks in the flowchart(s), can be implemented by special purpose hardware-based computer systems which perform the specified functions, or combinations of special purpose hardware and computer instructions.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1-34. (canceled)

35. An apparatus, comprising:
at least one processor; and
at least one memory storing instructions that, when executed by the at least one processor, cause the apparatus to at least perform:
receive information regarding an uplink sounding reference signal frequency hopping pattern for positioning;
determine a frequency domain allocation to implement the uplink sounding reference signal frequency hopping pattern, wherein determining the frequency domain allocation comprises determining a relative location of one or more physical resource blocks of a frequency hop that overlap a portion of another frequency hop and identifying the one or more physical resource blocks of the frequency hop to be located at the top or bottom of the frequency domain allocation of the frequency hop; and
cause transmission of sounding reference signals in accordance with the frequency domain allocation that implements the uplink sounding reference signal frequency hopping pattern to at least one base station.

36. The apparatus of claim 35, wherein the information regarding the uplink sounding reference signal frequency hopping pattern comprises an indication of the starting hop location and relative offsets of subsequent hops.

37. The apparatus of claim 35, wherein the uplink sounding reference signal frequency hopping pattern comprises one or more frequency hopping patterns, wherein each individual hopping pattern is associated with an index.

38. The apparatus of claim 37, wherein the information that is received comprise an indication of the index associated with one or more frequency hopping patterns via at least one of radio resource control or downlink control information.

39. The apparatus of claim 35, wherein the information regarding the uplink sounding reference signal frequency hopping pattern for positioning comprises an index or a starting hop associated with a pre-defined or pre-configured hopping pattern.

40. The apparatus of claim 39, wherein the pre-defined or pre-configured hopping pattern includes a hopping pattern comprising frequency hop locations 1, 4, 2, 3, and 0, sequentially.

41. The apparatus of claim 35, wherein the instructions, when executed by the at least one processor, further cause the apparatus to configure one or more uplink frequency hopping patterns based on the frequency domain allocation, a number of frequency hops, and/or the relative location of one or more physical resource blocks.

42. The apparatus of claim 41, wherein the instructions, when executed by the at least one processor, further cause the apparatus to receive at least one of the number of frequency hops and/or a starting hop of the frequency hopping pattern.

43. An apparatus comprising:
at least one processor; and
at least one memory storing instructions that, when executed by the at least one processor, cause the apparatus to at least perform:
receive a request for configuring at least one user equipment with an uplink sounding reference signal frequency hopping pattern;
determine at least one uplink sounding reference signal frequency hopping pattern for the at least one user equipment; and
cause the at least one user equipment to be configured with the uplink sounding reference signal frequency hopping pattern for positioning, wherein causing the at least one user equipment to be configured comprises causing an indication to be provided as to a relative location of one or more physical resource blocks of a frequency hop that overlap a portion of another frequency hop.

44. The apparatus of claim 43, wherein the instructions, when executed by the at least one processor, further cause the apparatus to: determine the frequency hops of an uplink sounding reference signal frequency hopping pattern of a respective user equipment based on an uplink sounding reference signal frequency hopping pattern of one or more other user equipment.

45. The apparatus of claim 43, wherein the instructions, when executed by the at least one processor, further cause the apparatus to: measure at least one uplink sounding reference signal provided by a respective user equipment in accordance with the uplink sounding reference signal frequency hopping pattern.

46. The apparatus of claim 45, wherein the instructions, when executed by the at least one processor, further cause the apparatus to: cause a report of measurements of the uplink sounding reference signal to be generated and transmitted to a location management function.

47. The apparatus of claim 43, wherein the relative location of the one or more physical resource blocks of the frequency hop that overlap the portion of another frequency hop identifies the one or more physical resource blocks of the frequency hop to be located at the top or bottom of a frequency domain allocation of the frequency hop.

48. The apparatus of claim 47, wherein an indication of the one or more physical resource blocks that overlap the portion of another frequency hop is determined based on a top and/or bottom physical resource block of a carrier.

49. The apparatus of claim 43, wherein the instructions, when executed by the at least one processor, further cause the apparatus to: cause transmission of the uplink sounding reference signal frequency hopping pattern to a location management function.

50. A method comprising:
receiving information regarding an uplink sounding reference signal frequency hopping pattern for positioning;
determining a frequency domain allocation to implement the uplink sounding reference signal frequency hopping pattern, wherein determining the frequency domain allocation comprises determining a relative location of one or more physical resource blocks of a frequency hop that overlap a portion of another frequency hop and identifying the one or more physical resource blocks of the frequency hop to be located at the top or bottom of the frequency domain allocation of the frequency hop; and
causing transmission of sounding reference signals in accordance with the frequency domain allocation that implements the uplink sounding reference signal frequency hopping pattern to at least one base station.

51. The apparatus of claim 50, wherein the information regarding the uplink sounding reference signal frequency hopping pattern comprises an indication of the starting hop location and relative offsets of subsequent hops.

52. The apparatus of claim 50, wherein the uplink sounding reference signal frequency hopping pattern comprises one or more frequency hopping patterns, wherein each individual hopping pattern is associated with an index.

53. The apparatus of claim 50, wherein the information regarding the uplink sounding reference signal frequency hopping pattern for positioning comprises an index or a starting hop associated with a pre-defined or pre-configured hopping pattern.

54. The apparatus of claim 53, wherein the pre-defined or pre-configured hopping pattern includes a hopping pattern comprising frequency hop locations 1, 4, 2, 3, and 0, sequentially.
